(19) United States
(12) Patent Application Publication
(10) Pub. No.: US 2010/0130288 A1
(43) Pub. Date: May 27, 2010

(54) RFID-INCORPORATED GAME TOKEN AND MANUFACTURING METHOD THEREOF

(75) Inventor: Yasushi Shigeta, Osaka (JP)

Correspondence Address: LOWE HAUPTMAN HAM & BERNER, LLP, 1700 DIAGONAL ROAD, SUITE 300, ALEXANDRIA, VA, 22314, US

(73) Assignee: ANGEL PLAYING CARDS CO., LTD., Osaka (JP)

(21) Appl. No.: 12/593,668

(22) PCT Filed: Mar. 28, 2008
(86) PCT No.: PCT/JP2008/056186

§ 371 Date: Jan. 10, 2010

(30) Foreign Application Priority Data
Mar. 30, 2007 (JP) 2007-093931

(51) Int. Cl. A63F 9/24; B32B 37/00; B32B 38/04

(52) U.S. Cl. 463/47; 156/60; 156/250

(57) ABSTRACT

An RFID tag incorporated game token that does not allow the RFID tag to be easily removed and hardly has failures in the RFID tag during manufacturing or in use is implemented. In the game token, an RFID covered with flexible cover sheets is held between laminate resin films or plates, and these elements are thermally press-bonded, so that the RFID tag is incorporated in a body. The material of the cover sheet is paper, vinyl chloride, polyethylene terephthalate or the like.

### TECHNICAL FIELD

The present invention relates to tokens for use in games and more particularly to an RFID-incorporated game token.

### BACKGROUND ART

In recent years, as the development of RFID tags has been advanced, the incorporation of an RFID tag in a token for a game has been suggested. For example, U.S. Pat. No. 6,659,875 discloses the arrangement in which an IC chip and an antenna are directly adhered to the backside of the front surface label of a token.

### DISCLOSURE OF THE INVENTION

### Problems to be Solved by the Invention

However, in the arrangement disclosed by U.S. Pat. No. 6,659,875, the IC chip can easily be removed or replaced by a different IC chip by peeling off the front surface label. Since the IC chip and the antenna are directly adhered to the backside of the front surface label, the IC chip can easily be damaged when the token is manufactured or used. In view of the problem, it is therefore an object of the present invention to provide a game token that does not allow an RFID tag to be easily removed and hardly has failures in the RFID tag during manufacturing or in use.

### Means for Solving the Problems

In order to achieve the above-described object, a game token according to the present invention includes resin plates, and an RFID tag held between the resin plates while it is covered with sheets having flexibility or plasticity.

In this arrangement, the RFID tag is held between the resin plates, and the RFID tag cannot easily be removed. It can also resist externally applied stress. The RFID tag is covered with sheets having flexibility, and therefore when the RFID tag is held between the resin plates, the RFID tag can be prevented from being damaged in the fixing step for example by thermal press-bonding of the resin plates. Therefore, a game token that does not allow an RFID tag to be easily removed and hardly has failures in the RFID tag during manufacturing or in use can be provided.

In the game token according to the present invention, the material of the sheet is preferably paper. Alternatively, it is also preferable to use vinyl chloride or polyethylene terephthalate.

In the game token according to the present invention, the body may be rectangular or disk-shaped.

In the game token according to the present invention, the area of the RFID tag covered with the sheets is preferably smaller than the area of the resin plates. Alternatively, the resin plate may be extended to a side surface of the game token. In this way, the RFID tag is not exposed when viewed from the side surface of the game token, which aesthetically improves the appearance of the token.

In order to achieve the above-described object, by a method of manufacturing a game token according to the present invention manufactures a game token formed by holding an RFID tag covered with sheets between resin plates, the sheets have flexibility or plasticity, and the method includes the steps of forming a layered body by holding the RFID tag covered with the sheets having flexibility or plasticity between resin plates or resin films to be a material for the resin plates, and thermally press-bonding the layered body.

By the manufacturing method, the RFID tag is held between the resin plates, and therefore the RFID tag cannot be removed from the manufactured token and the token is resistant to externally applied stress. The RFID tag is covered with sheets having flexibility or plasticity, and therefore the RFID tag can be prevented from being damaged in the step of thermal press-bonding. Consequently, a game token that does not allow an RFID tag to be easily removed and hardly has failures in the RFID tag during manufacturing or in use can be provided.

By the method of manufacturing a game token according to the present invention, the step of forming the layered body preferably includes the step of holding a plurality of RFID tags between resin films or resin plates having a size corresponding to the plurality of RFID tags as the resin films or resin plates, and the method preferably further includes the step of cutting individual game tokens out from the thermally press-bonded layered body after the step of thermally press-bonding the layered body.

By the manufacturing method, a plurality of game tokens can be produced by a single thermal press-bonding step, and therefore a high yield is achieved.

By the method of manufacturing a game token according to the present invention, the step of forming the layered body includes the step of holding an RFID tag sheet between resin films or resin plates having a size corresponding to a plurality of RFID tags, the RFID tag sheet including the plurality of RFID tags covered with the flexible sheets, and the method preferably further includes the step of cutting individual game tokens out from the thermally press-bonded layered body after the step of thermally press-bonding the layered body.

By the manufacturing method, a plurality of game tokens can be produced by a single thermal press-bonding step and the step of cutting the RFID tags out from the RFID tag sheet is not necessary, so that an even higher yield is achieved.

### Effects of the Invention

As in the foregoing, according to the present invention, a game token that does not allow an RFID tag to be easily removed and hardly has failures in the RFID tag during manufacturing or in use can be provided.

### BRIEF DESCRIPTION OF THE DRAWINGS

FIG. 1A is a perspective view of a chip according to a first embodiment of the present invention.

FIG. 1B is a sectional view taken along A-A′ in FIG. 1A.

FIG. 2 is a partly cutaway plan view of the structure of a core incorporated in the chip according to the first embodiment.

FIGS. 3A to 3C are views schematically showing main manufacturing steps for a core.

FIG. 4 is an exploded perspective view showing an example of a method of manufacturing the chip according to the first embodiment.

FIG. 5 is an exploded perspective view of another example of the method of manufacturing the chip according to the first embodiment.

FIG. 6 is an exploded perspective view showing yet another example of the method of manufacturing the chip according to the first embodiment.

FIGS. 7A and 7B are exploded perspective views showing a further example of the method of manufacturing the chip according to the first embodiment.

FIGS. 8A to 8C are views schematically showing main manufacturing steps for a chip according to a second embodiment of the present invention.

FIG. 9 is a sectional view showing the structure of the chip according to the second embodiment.

FIGS. 10A to 10C are views schematically showing main manufacturing steps for a chip according to a third embodiment of the present invention.

FIG. 11 is a sectional view showing the structure of the chip according to the third embodiment.

FIGS. 12A to 12C are views schematically showing main manufacturing steps for a chip according to a fourth embodiment of the present invention.

FIG. 13 is a sectional view showing the structure of the chip according to the fourth embodiment.

FIGS. 14A to 14C are views schematically showing main manufacturing steps for a chip according to a modification of the fourth embodiment of the present invention.

FIG. 15 is a sectional view of the structure of the chip according to the modification of the fourth embodiment.

FIGS. 16A and 16B are sectional views showing the structure of a chip according to a fifth embodiment of the present invention.

FIG. 17 is a sectional view showing the structure of a chip according to a modification of the fifth embodiment.

### BEST MODE FOR CARRYING OUT THE INVENTION

Now, embodiments of the present invention will be described in detail in conjunction with the accompanying drawings.

### First Embodiment

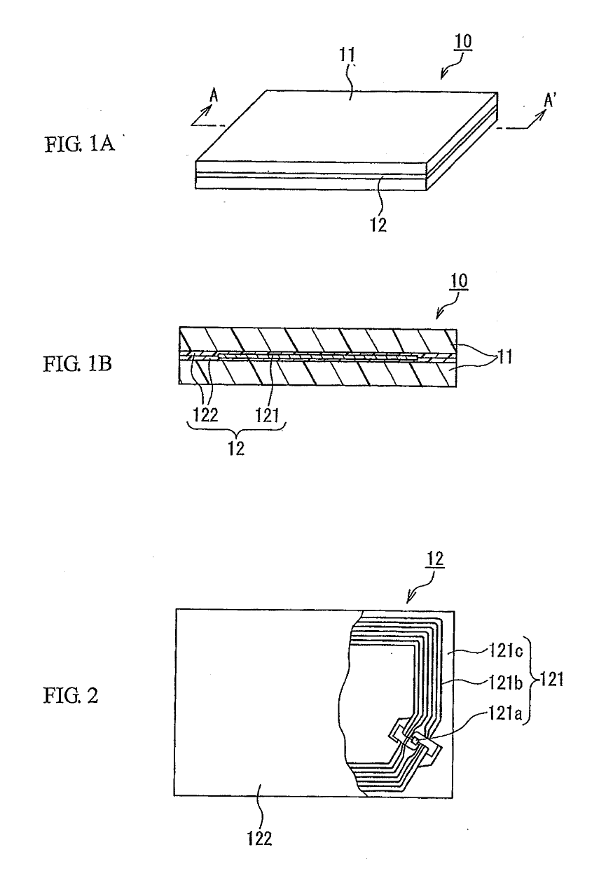

FIG. 1 shows the structure of a game token (hereinafter referred to as “chip”) 10 according to a first embodiment of the present invention. FIG. 1A is a perspective view of the chip 10 and FIG. 1B is a sectional view of the chip 10 taken along A-A′ in FIG. 1A. Note that in FIGS. 1A, 1B and 2 and the other figures, elements of each chip are not drawn in actual size. For example, in FIG. 1B, the thickness of the elements inside the chip is emphasized for ease of illustration of the inside structure of the chip.

As shown in FIGS. 1A and 1B, the chip 10 according to the first embodiment includes two rectangular resin plates 11 and a core 12 held between the two resin plates 11. The core 12 includes an RFID tag 121 and cover sheets 122 that cover the entire RFID tag 121. The resin plates 11 are formed by providing resin films of a material such as vinyl chloride and polyethylene terephthalate upon each other and thermally press-bonding them. A number, a sign, a pattern or the like corresponding to the value of the chip 10 is printed on the surfaces of the resin plates 11 in some cases. Alternatively, a label or protection layer made of the same material/a different material as/from the resin plates 11 may be adhered on the surfaces of the resin plates 11.

Now, with reference to FIG. 2, the structure of the core 12 will be described. As described in conjunction with FIG. 1, the core 12 includes the RFID tag 121 and the cover sheets 122 that cover the RFID tag 121. As shown in FIG. 2, the RFID tag 121 is formed by having an IC chip 121a and an antenna 121b provided on a single base film 121c or held between two base films 121c. Note that how to connect the IC chip 121a and the antenna 121b in the RFID tag 121 and the pattern shape or the like of the antenna 121b on the base film 121c are arbitrary and not limited to the arrangement shown in FIG. 2.

The IC chip 121a can be recorded with various kinds of information. Examples of such information include information indicating the value of the chip 10, information indicating the manufacturer of the chip 10, information indicating the owner of the chip 10, information indicating the date of manufacture of the chip 10, information indicating the date on which the chip 10 was obtained by the owner, information indicating the period in which the chip 10 can effectively be used and information indicating the place where the chip 10 can effectively be used. Needless to say, information that can be recorded on the IC chip 121a is not limited to the above-described examples.

The cover sheet 122 is a sheet used to cover the entire RFID tag 121 and paper, vinyl chloride, polyethylene terephthalate, or the like is suitably used for the material. The cover sheets 122 serve to protect the RFID tag 121 during thermal press bonding with the resin plates 11. The cover sheet 122, as will be described, needs only have such a degree of flexibility or plasticity that it conforms to the surface of the RFID tag 121 and can adhere to the other cover sheet 122 around the RFID tag 121 when the sheets hold the RFID tag 121 therebetween.

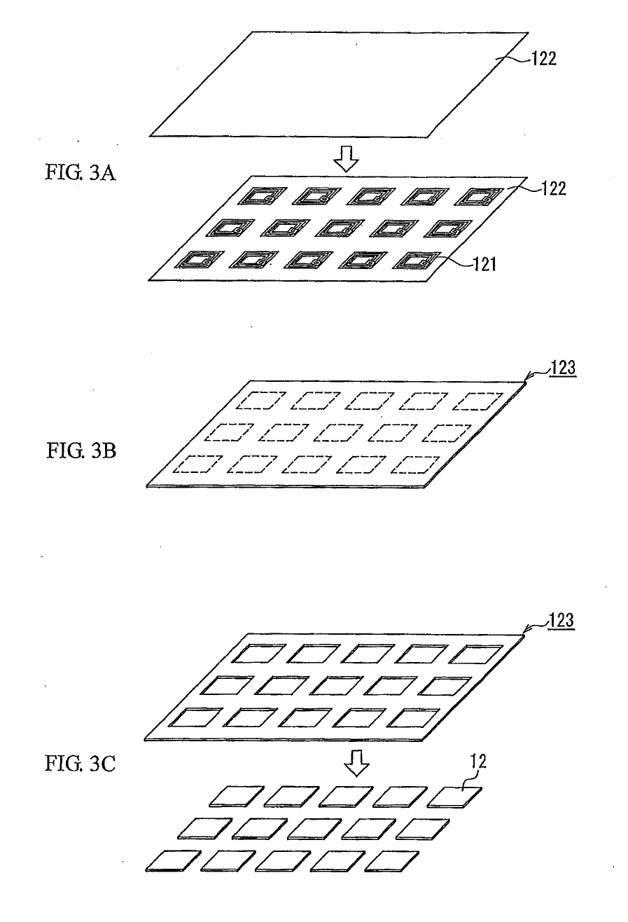

Now, with reference to FIG. 3, an example of a method of manufacturing the core 12 will be described. In this example, an adhesive (not shown) is applied on a cover sheet 122, a plurality of RFID tags 121 are arranged at prescribed intervals as shown in FIG. 3A. Then, another cover sheet 122 is placed thereon, and then the two cover sheets 122 are laminated to each other by the adhesive. In this way, as shown in FIG. 3B, an RFID tag sheet 123 having the plurality of RFID tags 121 held between the two cover sheets 122 is formed. Note that FIGS. 3A and 3B show examples only and the number of RFID tags 121 arranged on the cover sheet 122 is arbitrary.

Then, the cores 12 are cut from the RFID tag sheet 123 as shown in FIG. 3C by punching processing so that each core has a contour slightly larger than the contour of the RFID tag 121. Through the above-described steps, the cores 12 are produced.

In the example shown in FIG. 3, the RFID tag 121 is directly held between the two cover sheets 122, but a cushion member (not shown) may be interposed between the RFID tag 121 and at least one of the two cover sheets 122. This is because the use of the cushion material can prevent problems such as disconnection of the antenna 121b and connection failures between the IC chip 121a and the antenna 121b when stress is applied for example in the process of incorporating the core 12 between the resin plates 11. Alternatively, for the same purpose, the cover sheet 122 itself is preferably a cushiony material. In another example, the adhesive may be applied thickly, so that the adhesive serves as a cushion material.

In the example shown in FIG. 3, the plurality of RFID tags 121 that have been separated in advance are arranged on the cover sheet 122, but a plurality of IC chips 121a and a plurality of antennas 121b may be formed at prescribed intervals on a single large base film 121c and the whole structure may be held between two cover sheets 122, followed by adhesion, and the cores 12 may be obtained by punching.

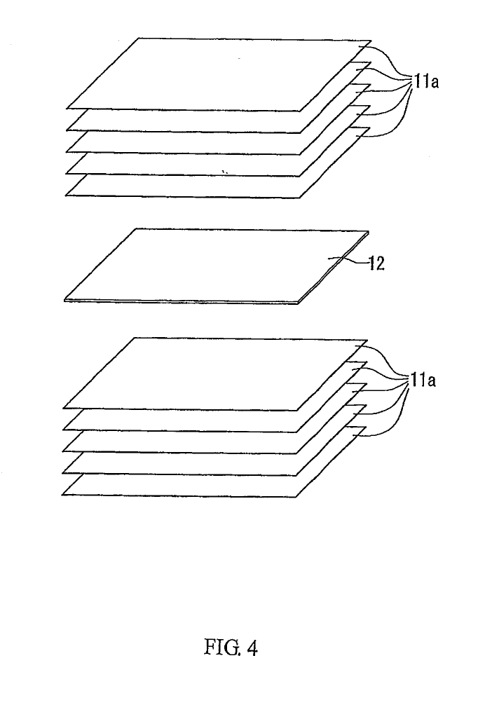

The core 12 obtained in this way is held between a plurality of resin films 11a as shown in FIG. 4 and subjected to thermal press-bonding, so that the chip 10 having the sectional structure shown in FIG. 1B is completed. More specifically, the plurality of resin films 11a are thermally press-bonded to form the resin plates 11 that have the core 12 held therebetween. Note that in the example shown in FIG. 4, five such resin films 11a are each layered on and under the core 12, while the number of resin films to be layered is not limited to the above example.

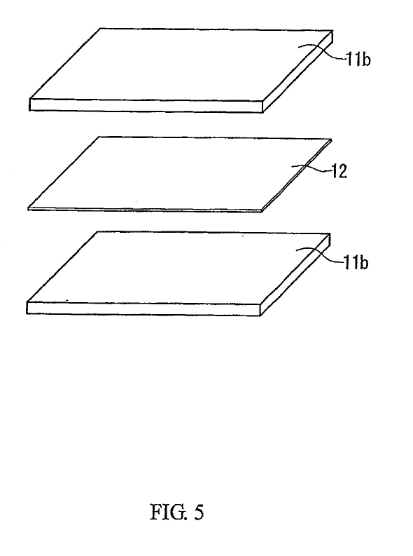

In the example in FIG. 4, the plurality of resin films 11a are arranged on and under the core 12 and subjected to thermal press-bonding, while as shown in FIG. 5, two preformed resin plates 11b may be prepared, and the core 12 may be held between the two resin plates 11b and subjected to thermal press-bonding or adhered by an adhesive. Note that the resin plate 11b may be formed by thermal press-bonding a plurality of resin films or by injection molding. In the step shown in FIG. 5 as compared to the step shown in FIG. 4, the time during which the RFID tag 121 is subjected to the heat and pressure can be reduced, so that the RFID tag 121 can be prevented from being damaged and the yield can be improved.

As in the foregoing, the chip 10 according to the present embodiment has the RFID tag 121 held between the two resin plates 11. Therefore, the RFID tag 121 cannot be removed from the chip 10. The RFID tag 121 is covered with the cover sheets 122 and therefore the RFID tag 121 can be prevented from being damaged when the core 12 is held between the resin films 11a or the resin plates 11b and subjected to thermal press-bonding.

In the foregoing description, the chip 10 has a rectangular shape by way of illustration, but the outer shape of the chip is not limited to the rectangular shape, and the chip may have a disk shape as a modification of the first embodiment.

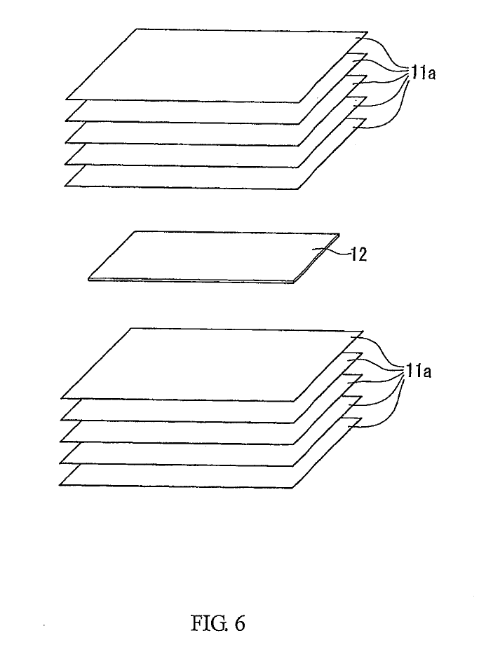

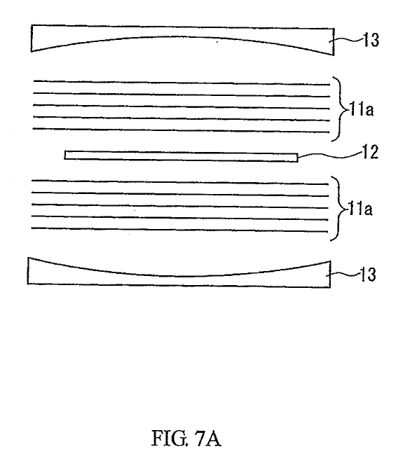

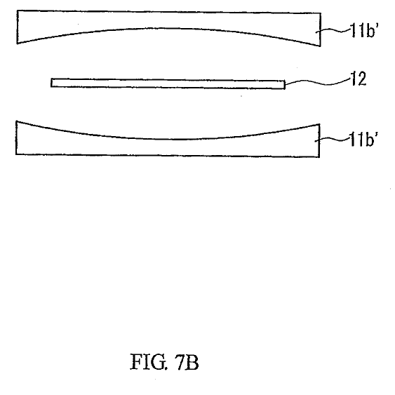

In the examples shown in FIGS. 4 and 5, the area of the core 12 is substantially equal to that of the resin film 11a or the resin plate 11b, and therefore an end of the core 12 is exposed at a side surface of the chip 10 as shown in FIG. 1B. In order to aesthetically improve the appearance of the chip 10, the area of the core 12 is preferably made slightly smaller than that of the resin film 11a (or the resin plate 11b) as shown in FIG. 6, so that the end of the core 12 does not appear at the side surface of the chip 10. If the core 12 is sufficiently thin and the area of the core 12 is slightly smaller than the area of the resin film 11a, the uniformity in the thickness of the chip 10 as a whole is not impaired. If the core 12 is relatively thick, rolling processing can be carried out with an amount of heat and a level of pressure that do not destroy the RFID tag 121 in order to equalize the thickness of the chip 10 as a whole. Alternatively, as shown in FIG. 7A, resin covers 13 each having four side ends thicker than the center may be layered at the outer side of the resin films 11a and the covers and the resin films 11a may be thermally press-bonded, so that the thickness of the chip 10 as a whole is equalized. As shown in FIG. 7B, the core 12 may be held between two resin plates 11b′ each formed to have four side ends thicker than the center, followed by thermal press-bonding or adhesion, so that the thickness of the chip 10 as a whole may be equalized.

Note that according to the present embodiment, the core is held between the two resin plates by way of illustration, but the number of resin plates arranged to hold the core therebetween is not limited to two.

### Second Embodiment

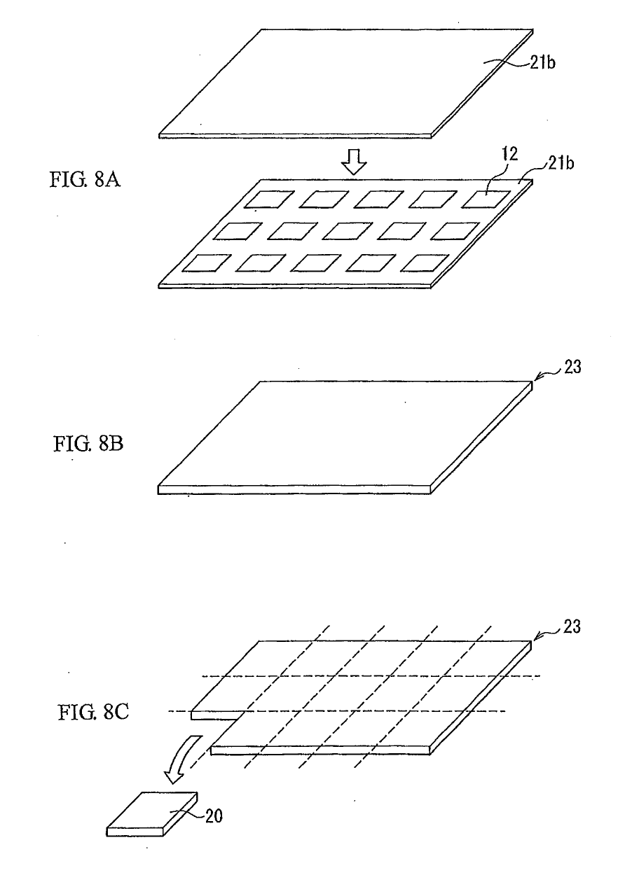

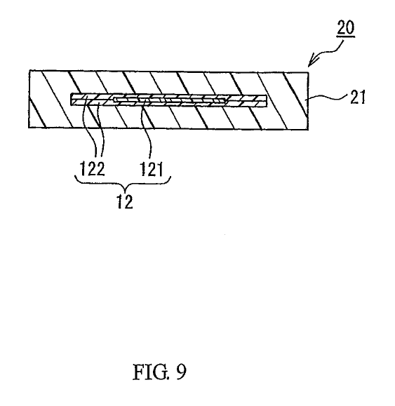

FIGS. 8A to 8C are schematic views showing the steps of manufacturing a chip according to a second embodiment of the present invention. FIG. 9 is a sectional view of the structure of a chip 20 produced by the manufacturing steps shown in FIGS. 8A to 8C. Note that the overall shape of the chip 20 may be rectangular or disk-shaped. The components described in connection with the first embodiment will be designated by the same reference characters and their detailed description will not be repeated.

As shown in FIG. 9, the chip 20 according to the second embodiment has a core 12 incorporated in a body 21 made of resin. The chip 20 is produced by the following steps.

To start with, as shown in FIG. 8A, a plurality of cores 12 are arranged at prescribed intervals on a resin plate 21b. The resin plate 21b may be formed by thermally press-bonding a plurality of resin films to each other or may be formed by injection molding. The number of cores 12 arranged on a single resin plate 21b is arbitrary. At the time, an adhesive may be applied on the resin plate 21b before the cores 12 are provided. Thereafter, another resin plate 21b is placed thereon and subjected to thermal press-bonding. In this way, as shown in FIG. 8B, a layered body 22 including the two resin plate 21b having the cores 12 held therebetween is produced by fusion press-bonding. Then, as shown in FIGS. 8C and 9, the layered body 22 is cut into pieces in a prescribed size or cut by punching, so that rectangular chips 20 having RFID tags 121 incorporated in the bodies 21 are completed.

As in the foregoing, the chip 20 according to the present embodiment has the RFID tag 121 incorporated in the body 21. Therefore, the chip 20 cannot be removed from the RFID tag 121. The RFID tag 121 is covered with cover sheets 122, and therefore the RFID tag 121 can be prevented from being damaged when the core 12 is held between the resin plates 21b and subjected to thermal press-bonding.

By the method according to the second embodiment, a plurality of chips 20 can be produced by a single thermal press-bonding step, so that the yield is higher than that in the first embodiment.

Note that in FIG. 8, the core 12 is held between the two resin plates 21b by way of illustration, while a plurality of resin films to be laminated may have a core 12 therebetween as shown in FIG. 4 in connection with the first embodiment, and the structure may be thermally press-bonded at a time. The number of resin plates or resin films used to hold the core 12 is arbitrary.

### Third Embodiment

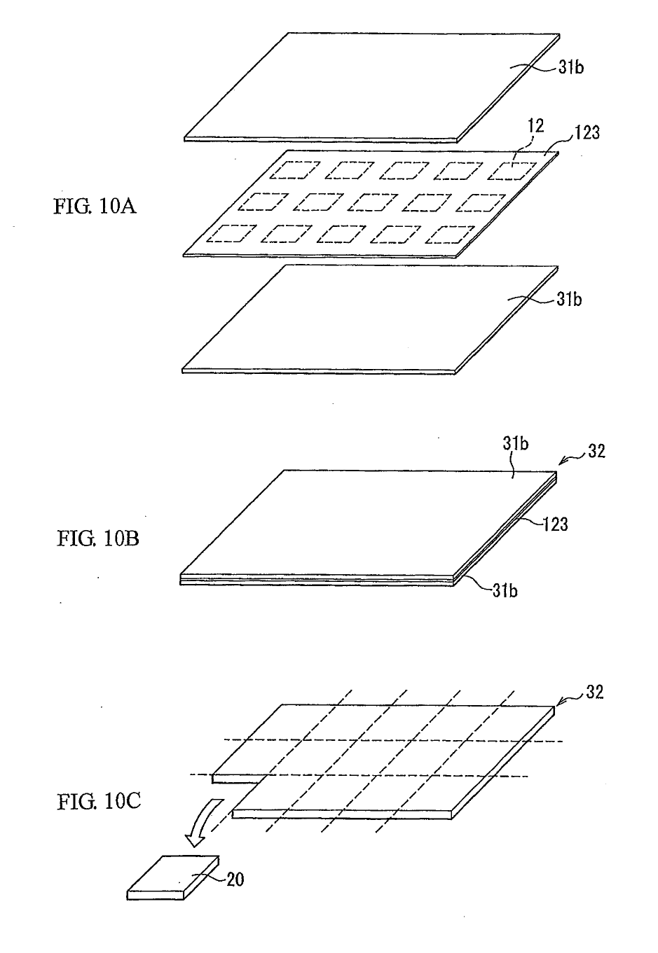

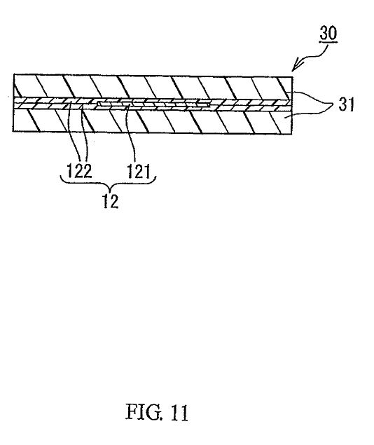

FIGS. 10A to 10C are schematic views showing the steps of manufacturing a chip according to a third embodiment of the present invention. FIG. 11 is a sectional view of the structure of a chip 30 produced by the manufacturing steps shown in FIGS. 10A to 10C. Note that the overall shape of the chip 30 may be rectangular or disk-shaped.

As shown in FIG. 11, the chip 30 according to the third embodiment has a core 12 held between two resin plates 31. As can be understood from comparison between FIGS. 1B and 11, the chip 30 according to the third embodiment has the same structure as the chip 10 according to the first embodiment but their manufacturing methods are different. The chip 30 is produced by the following steps using an RFID tag sheet 123 shown in FIG. 3B in connection with the first embodiment.

To start with, as shown in FIG. 10A, two large resin plates 31b having a size equal to a plurality of resin plates 31 are prepared, and an RFID tag sheet 123 is arranged between the two plates, followed by thermal press-bonding. Note that the resin plate 31b may be formed by thermally press-bonding a plurality of resin films or formed by injection molding. In this way, as shown in FIG. 10B, a layered body 32 including the RFID tag sheet 123 held between the two resin plates 31b is formed. Then, the layered body 32 is cut or punched into pieces in a prescribed size, and a rectangular chip 30 having an RFID tag 121 held between the two resin plates 31 is completed as shown in FIGS. 10C and 11.

As in the foregoing, the chip 30 according to the present embodiment includes the RFID tag 121 held between the two resin plates 31. Therefore, the RFID tag 121 cannot be removed from the chip 30. The RFID tag 121 is covered with cover sheets 122, and therefore the RFID tag 121 can be prevented from being damaged when the RFID tag sheet 123 held between the resin plates 31b is subjected to thermal press-bonding.

By the method according to the third embodiment, a plurality of chips 30 can be produced by a single thermal press-bonding step and the step of cutting the RFID tags 121 from the RFID tag sheet 123 by punching is not necessary, so that the yield is higher than those by the methods according to the first and second embodiments.

Note that in FIG. 10, the RFID tag sheet 123 is held between the two resin plates 31b formed by laminating the resin films in advance by way of illustration, but as shown in FIG. 4 in connection with the first embodiment, the RFID tag sheet 123 may be held between a plurality of resin films before lamination and subjected to thermal press-bonding at a time.

### Fourth Embodiment

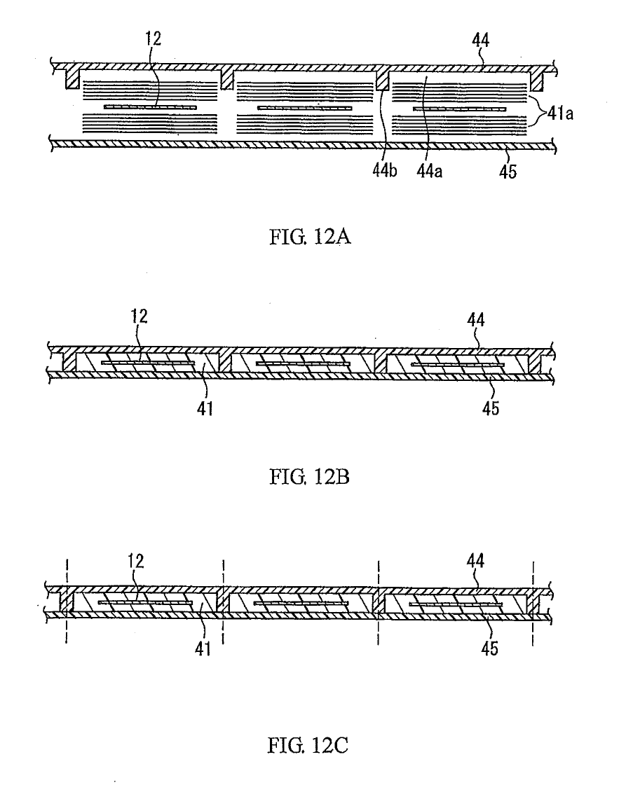

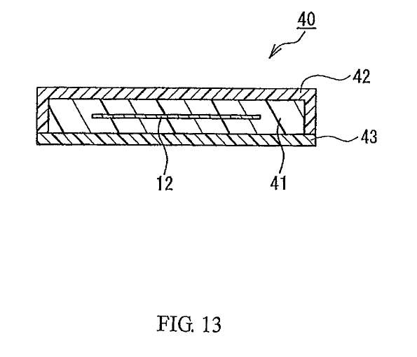

FIGS. 12A to 12C are views schematically showing the steps of manufacturing a chip according to a fourth embodiment of the present invention. FIG. 13 is a sectional view of the structure of the chip 40 produced by the manufacturing steps shown in FIGS. 12A to 12C. Note that the overall shape of the chip 40 may be rectangular or disk-shaped.

As shown in FIG. 13, in the chip 40 according to the fourth embodiment, a core 12 including an RFID tag 121 is embedded in a resin layer 41, and the entire outer part of the resin layer 41 is covered with an upper cover 42 and a lower cover 43 made of resin. The upper cover 42 is arranged to cover one main surface and four side surfaces of the resin layer 41. The lower cover 43 is arranged to cover the other main surface of the resin layer 41. In FIG. 13, for ease of illustration of the sectional structure, the boundary line between the upper and lower covers 42 and 43 and the resin layer 41 and the boundary line between the upper and lower covers 42 and 43 are indicated. However, the resin is fused to integrate the upper cover 42, the lower cover 43 and the resin layer 42 in some cases and the boundary lines between them may not be clearly defined in such cases.

Now, with reference to FIGS. 12A to 12C, the steps of manufacturing the chip 40 will be described. As shown in FIG. 12A, a plurality of resin films 41a are provided on a flat resin plate 45 as a material for the lower cover 43 with a core 12 interposed therebetween. A large resin plate 44 as a material for the upper cover 42 is provided thereon. Note that at the back surface of the resin plate 44, rectangular recessed parts 44a each slightly smaller than the main surface of the chip 40 and raised parts 44b that define the recessed parts 44a are formed. More specifically, the resin film 41a has substantially the same area as that of the recessed part 44a so that the resin films 41a are fitted into the space formed by the recessed part 44a between the resin plates 44 and 45 when these plates are press-bonded.

When the resin plates 44 and 45 are thermally press-bonded, the resin of the resin films 41a is fused, and as shown in FIG. 12B, a resin layer 41 that fills the space formed by the recessed part 44a between the resin plates 44 and 45 is formed. Therefore, the material for the resin film 41a is preferably resin that can be fused about at temperatures at which the RFID tag 121 is not destroyed. Then, as shown in FIG. 12C, cutting is carried out along the raised parts 44b, so that the chip 40 having the structure shown in FIG. 13 is completed.

As in the foregoing, in the chip 40 according to the present embodiment, the RFID tag 121 is embedded in the resin layer 41, the outer side of the resin layer 41 is covered with the upper and lower covers 42 and 43. Therefore, the RFID tag 121 cannot be removed from the chip 40. The RFID tag 121 is covered with cover sheets 122, and therefore the RFID tag 121 can be prevented from being damaged when the resin films 41a are thermally press-bonded. By the method according to the present embodiment, a plurality of chips 40 can be produced by a single thermal press-bonding step, so that a high yield is achieved.

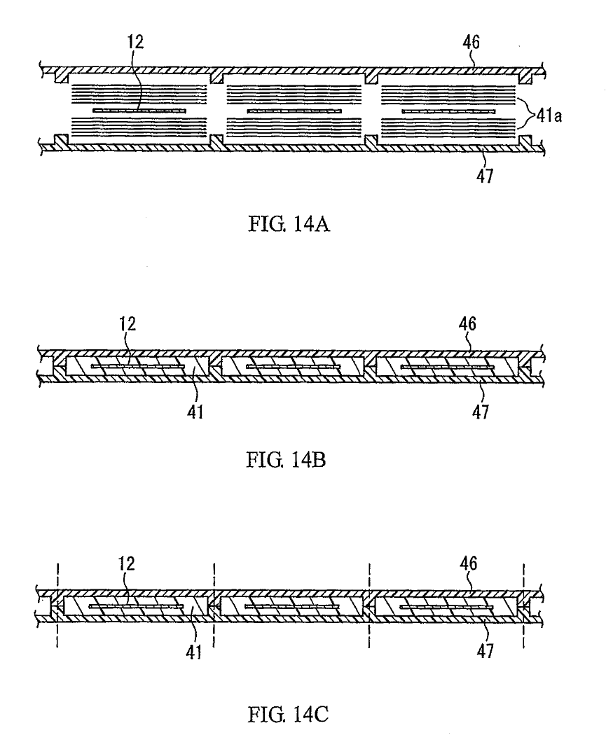

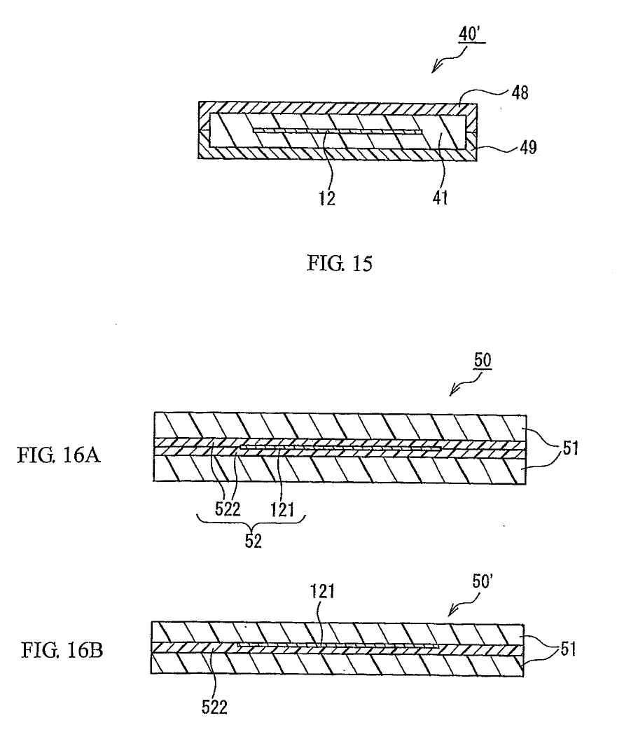

Note that in FIG. 13, the lower cover 43 has a flat plate shape and covers only one main surface of the chip 40 while a modification as shown in FIG. 15 can also be employed. In the chip 40′ according to the modification shown in FIG. 15, one main surface of the chip and the upper half of four side surfaces are covered with an upper cover 48 and the other main surface and the lower half of the four side surfaces are covered with a lower cover 49. As shown in FIGS. 14A to 14C, the chip 40′ can be produced by the same steps as those shown in FIGS. 12A to 12C by using resin plates 46 and 47 symmetrical to each other in the vertical direction instead of the resin plates 44 and 45 shown in FIG. 12.

### Fifth Embodiment

FIG. 16A is a sectional view of the structure of a chip 50 according to a fifth embodiment of the present invention. The overall shape of the chip 50 may be rectangular or disk-shaped.

As shown in FIG. 16A, a core 52 having an RFID tag 121 incorporated therein is held between two resin plates 51. The core 52 has the RFID tag 121 held between sheets 522 with plasticity and has a substantially uniform thickness. Therefore, when the core 12 is held between the resin plates 51, the thickness of the chip 50 as a whole is substantially uniform. Paper or resin for example may be used for the material of the sheets 522.

Note that like a chip 50′ shown in FIG. 16B, an RFID tag 121 may be embedded in a single sheet 522 having plasticity so that the tag does not protrude beyond the surface and the resulting structure may be held between two resin plates 51.

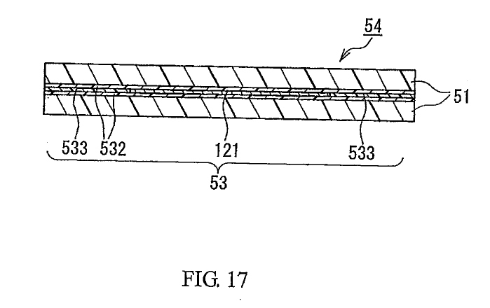

Alternatively, like a chip 54 shown in FIG. 17, a core 53 including an RFID tag 121 between two sheets 532 through an adhesive layer 533 may be formed, and the core 53 may be held between two resin plates 51. The adhesive layer 533 can adhere the two sheets 532, absorb the thickness of the RFID tag 121 and equalize the thickness of the core 53.

As in the foregoing, according to the present embodiment, the RFID tag 121 is held between the two resin plates 51. Therefore, the RFID tag 121 cannot be removed from the chip. The RFID tag 121 is covered with cover sheets 522 or 532, and therefore the RFID tag 121 can be prevented from being damaged when the core 52 or 53 and the resin plates 51 are thermally press-bonded.

### INDUSTRIAL APPLICABILITY

The present invention has industrial applicability in the field of game tokens.

1. A game token, comprising:
resin plates; and
an RFID tag held between the resin plates as it is covered with sheets having flexibility or plasticity.

2. The game token according to claim 1, wherein the sheet is a paper sheet.

3. The game token according to claim 1, wherein the sheet is a sheet of vinyl chloride or polyethylene terephthalate.

4. The game token according to claim 1, wherein the body is rectangular.

5. The game token according to claim 1, wherein the body is disk-shaped.

6. The game token according to claim 1, wherein the area of the RFID tag covered with the sheet is smaller than the area of the resin plate.

7. The game token according to claim 1, wherein the resin plate is extended to a side surface of the game token.

8. A method of manufacturing a game token formed by holding an RFID tag covered with sheets between resin plates, the sheet having flexibility or plasticity, the method comprising the steps of:
forming a layered body including the RFID tag covered with sheets having flexibility or plasticity between resin plates or resin films to be a material for the resin plates; and
fixing the layered body.

9. The method of manufacturing a game token according to claim 8, wherein the step of forming the layered body comprises the step of holding a plurality of RFID tags between resin films or resin plates having a size corresponding to the plurality of RFID tags as the resin films or resin plates,
the method further comprising the step of cutting individual game tokens out from the thermally press-bonded layered body after the step of fixing the layered body.

10. The method of manufacturing a game token according to claim 8, wherein the step of forming the layered body comprises the step of holding an RFID tag sheet between resin films or resin plates having a size corresponding to a plurality of RFID tags as the resin films or resin plates, the RFID tag sheet including a plurality of RFID tags covered with the flexible sheets,
the method further comprising the step of cutting individual game tokens out from the thermally press-bonded layered body after the step of fixing the layered body.
